(19) United States
(12) Patent Application Publication
(10) Pub. No.: US 2021/0218316 A1
(43) Pub. Date: Jul. 15, 2021

(54) ROTATING ELECTRICAL MACHINE, ELECTRIC MOTOR, VEHICLE HAVING AN ELECTRIC DRIVE, CAN AND PRODUCTION METHOD FOR SAME

(71) Applicant: Magna powertrain GmbH & Co KG, Lannach (AT)

(72) Inventor: Werner NESS, Manhartsbrunn (AT)

(21) Appl. No.: 17/251,776

(22) PCT Filed: May 21, 2019
(86) PCT No.: PCT/EP2019/063108

§ 371 Date: Dec. 11, 2020

(30) Foreign Application Priority Data
Jun. 12, 2018 (DE) 10 2018 209 367.9

(51) Int. Cl. H02K 9/197; H02K 5/20; H02K 15/14

(52) U.S. Cl. CPC H02K 9/197; H02K 15/14; H02K 5/203

(57) ABSTRACT

An electric machine has a rotor, a stator which is spaced apart from the rotor in a radial direction by a gap and which has one or more stator windings and winding heads at one or both axial ends of the stator, in the gap a tube with a fluid-tight wall which extends in an axial direction and in a circumferential direction and which has a wall thickness in a radial direction, wherein the tube extends in an axial direction beyond the winding heads of the stator at least one stator end, at least one cover, which extends radially and which covers the winding heads of the at least one axial end of the stator, at the at least one axial end of the tube, and a cooling fluid inlet and/or a cooling fluid outlet for a cooling fluid chamber which is closed by the tube and by the cover. At least regions of the tube are formed with a ferrite material.

### CROSS-REFERENCE TO RELATED APPLICATIONS

This application is a National Stage of International Application No. PCT/EP2019/063108, filed May 21, 2019, which claims priority to DE102018209367.9, filed Jun. 12, 2018. The entire disclosures of each of the above applications are incorporated herein by reference.

### FIELD OF THE INVENTION

The invention relates to a rotating electric machine, an electric motor, a vehicle with electric drive, a can and a production method for a can.

Vehicles with electric drive have one or more electric motors which are fed from an energy source (often a battery). During operation, even electric motors generate waste heat. Said waste heat is generated in such quantities that it must be taken into consideration in the design and must be dissipated.

The waste heat is also generated in the stator windings. Here, regions which are subject to particular high thermal load are often the winding heads, that is to say those parts of the winding lines which project in an axial direction out of the stator or out of the gaps thereof at the axial ends of the stator and which are connected to one another.

The problem of winding heads heating up arises in particular in the operating range of relatively high continuous loads or in the case of high peak loads. This then in fact often forms the effective system limit for the usable motor power in the case of present designs. If a shell-type cooling arrangement of the stator is provided, this benefits the stator body in particular. By contrast, the winding heads are situated remote from the heat sink, such that, for this reason alone, the winding heads firmly constitute the “bottleneck” in the cooling of the motor. As a remedy for the problem, oil-cooled motors are known in the case of which the entire interior space of the electric motor is washed around by circulated oil which serves as cooling fluid. A disadvantage of this construction is that the oil causes a drag torque (braking torque) for the motor, and the efficiency thereof thus decreases. Furthermore, the bearing arrangements of the rotor must be of fluid-tight design. Canned motors are a further remedy for the problem of overheating winding heads. In these, in the air gap between stator and rotor, there is a pipe which projects beyond the stator in both axial directions, as far as beyond the winding heads. Furthermore, covers are known by means of which a closed annular space around the winding heads can be formed if necessary by means of further components, for example housing walls. Said annular space is passed through by an actively circulated cooling fluid which dissipates waste heat that has been generated. A disadvantage of known canned motors is that they have a considerably widened air gap between stator and rotor in order to be able to accommodate the can therein. This is detrimental to the magnetic coupling between stator and rotor and thus to the efficiency.

### SUMMARY OF THE INVENTION

This section provides a general summary of the disclosure, and is not a comprehensive disclosure of its full scope or all of its features.

It is an object of the invention to specify an electric machine, an electric motor, a can and a production method for the same which allow good efficiency of an electric machine along with effective stator cooling, including of the winding heads.

Said object is achieved by means of the features of the independent patent claims.

A rotating electric machine is specified, having a rotor and having a stator which is spaced apart from the rotor in a radial direction by a gap and which has one or more stator windings and winding heads at the axial ends of the stator. In the gap between stator and rotor, there is inserted a tube with a fluid-tight wall which, in an axial direction, extends in an axial direction beyond the winding heads of the stator at at least one stator end. A fluid-tight volume in which the winding heads are situated is formed by means of a cover, which covers the winding heads in an axial direction, by means of the tube wall and by means of further regions (for example housing inner wall, stator surface).

The volume may be an annular chamber which extends in a circumferential direction of the electric machine with respect to the axis of rotation thereof. Said annular chamber is filled by a cooling fluid which is circulated and thus dissipates heat.

The tube is formed at least in regions with ferrite material. The tube together with the cover and possibly further conversion components (for example housing wall, stator material) forms a liquid-coolable volume in which the winding heads are situated, such that these are washed around by the cooling fluid and can thus be cooled in an efficient manner. The installation of the tube into the gap between stator and rotor initially leads to an increase in the gap width between the two. Since the tube is however formed with ferrite material, the gap volume can be filled with magnetically permeable material, such that the disadvantage of the wider gap is at least partially compensated.

The ferrite material has a relative magnetic permeability μr greater than 1. It may be greater than 5 or greater than 10 or greater than 20 or greater than 50. In this way, a rotating electric machine is obtained in which the winding heads are cooled in an effective manner without any disadvantages arising such as a drag torque as a result of oil in the housing or considerably reduced efficiency owing to a large gap width.

The ferrite material is defined by suitable characteristic values. It may have hematite (Fe2O3) and/or magnetite (Fe3O4), possibly in a suitable mixture. Coercive force and remanence of the hysteresis curve lie in defined ranges. The electrical conductivity is low and also lies in defined ranges. The wall thickness of the tube may, at least in the gap, lie in the range between half of one millimeter and 5 mm, preferably in the range between 1.5 mm and 3 mm, more preferably 2 mm ±10% or ±20%.

Preferably, the winding heads are surrounded at both ends of the stator by corresponding chambers, such that the winding heads at both ends are fluid-cooled. By means of lines in the stator or grooves in the housing wall, the chambers at the two stator ends can be fluidically connected (in an axial direction). One chamber is furthermore connected to a coolant inlet and/or a coolant outlet, to which suitable lines for the suitable conduction of the cooling fluid can be connected.

Depending on the cooling fluid, the fluid line may lead to a heat exchanger. This may be a heat exchanger of some other component with the same cooling fluid, or a dedicated heat exchanger. For an inverter, a heat exchanger for water-type cooling may be provided.

If the cooling fluid of the electric machine is likewise water, or likewise has water, the electric machine can be connected to the heat exchanger of the inverter.

It is however also possible for a dedicated heat exchanger to be provided, in particular if a heat exchanger is not already present. This may be the case for example if the cooling fluid is or has oil. The cooling fluid chambers that the winding heads project into are in this case preferably annular chambers which extend in a circumferential direction of the stator.

The winding heads are ultimately conductor loops of electrical conductors which project in cantilevered fashion into the chamber volume and are then washed around by the cooling fluid in the chamber. The can may be produced by means of suitable production methods. For example, as starting material, ferrite in a powder preparation may be used and processed further.

The further processing may for example comprise the production of a tubular body by sintering. Commonly, with respect to the radial direction in relation to the axis of rotation of the machine, the stator is situated radially at the outside and the rotor is situated radially at the inside. The covers that close the chamber then extend radially outward from the tube.

The described design may however also be used for external-rotor motors in the case of which the stator is situated radially at the inside. The winding heads are then also situated radially at the inside, and the covers extend from the can radially inward possibly as far as the (virtual) axis of rotation in order to enclose the stator and thus form the chamber for conducting the cooling fluid around the winding heads.

In any case, a free gap remains between pipe tube wall and rotor, such that the latter can rotate in a contact-free manner relative to the former. The gap width is selected in accordance with customary criteria and may lie between 0.4 mm and 1.5 mm, preferably between 0.5 mm and 1 mm. The magnetic characteristics of the ferrite may be isotropic or anisotropic.

If they are anisotropic, it is desirable for the magnetic permeability in a radial direction to be greater than that in a direction transverse thereto, and in particular to be at its greatest in a radial direction (at least 90% or 95% of the maximum value). The covers may be produced from different materials than the can or from the same material.

Said covers may have thermoplastics or thermosets as material. In one embodiment, the ferrite material is mixed with a carrier material, for example with a thermoplastic. This may be performed in each case in granular form at room temperature and/or in the softened or a liquid state of the thermoplastic. The starting material for the molding of the can may be a homogeneous mixture of ferrite material and carrier material (thermoplastic), which may initially be present in each case individually in powdered and/or granular form. This mixture is capable of being extruded or molded, such that the can is producible by extrusion or injection molding. It is then possible, for example in the case of injection molding, to produce relatively complex shapes of the can.

For example, it is even possible for one of the covers to be directly integrally molded onto the can, and for further structural features to be or become integrally formed (method).

Therefore, a method for producing a can for a rotating electric machine is also expressly specified. The method comprises providing a granular or powdered ferrite material, in particular a mixture of a powdered ferrite and a plastics material, adjusting the temperature of the mixture to a processing temperature, and producing a can by extrusion or injection molding of the mixture.

The plastics material may be a thermoplastic, or else may for example be a two-component thermoset. The ferrite material may however also be brought into the desired shape, for example sintered into shape, without additives.

During the production of the can, further structural features may be integrally formed on the tube, for example one of the abovementioned covers, preferably at one tube end and preferably so as to encircle the tube circumference and so as to extend in a radial direction, and/or fluid-guiding elements.

A can itself, composed of a material which has ferrite, is also specified.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically shows a cross section through a rotating electric machine in a section plane which encompasses the axis of rotation,

FIG. 2 schematically shows a conceivable cooling line structure,

FIG. 3 shows a can in a particular embodiment with further components,

FIG. 4 shows a structural form of the machine in one embodiment, and

FIG. 5 schematically shows a partial section through a rotating electric machine with section plane perpendicular to the axis of rotation.

### DESCRIPTION OF THE INVENTION

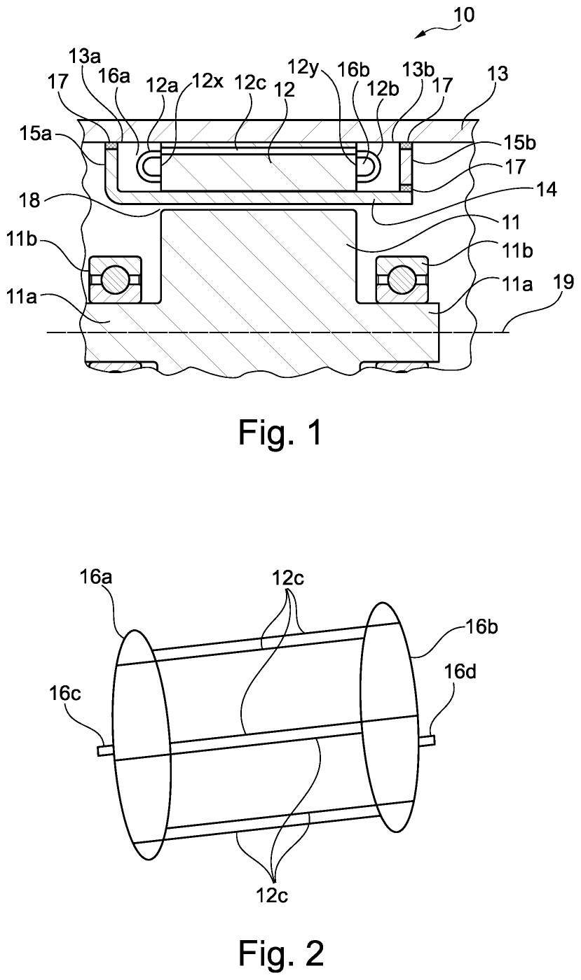

FIG. 1 shows a highly schematic section through a rotating electric machine, for example an electric motor. The axis of rotation 19 of the electric machine lies in the section plane. Only the upper half of the structure is shown. The half below the axis of rotation 19 may be substantially mirror-symmetrical with respect thereto, and is therefore not illustrated. 11 is the rotor of the motor, which is mounted so as to be rotatable about a shaft 11a, for example by ball bearings 11b. 19 is the axis of rotation of the rotor. 12 is the stator of the machine. In the embodiment shown, said stator is situated radially outside the rotor 11.

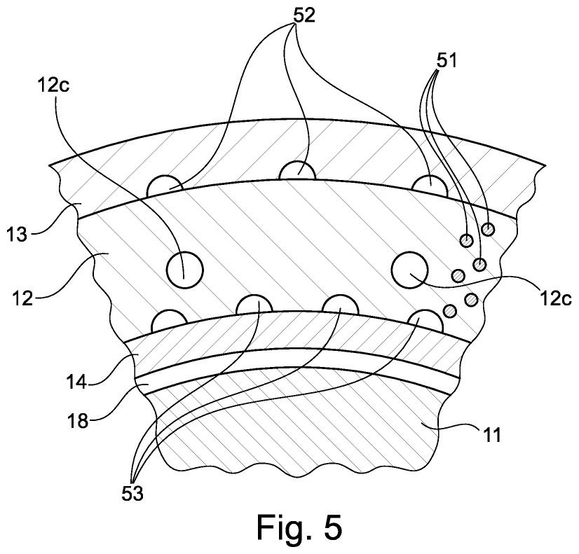

In general, stators are constructed, on the one hand, from iron components and, on the other hand, from winding lines, which is not illustrated in detail in FIG. 1 but is indicated in FIG. 5. The iron components are commonly laminated cores which are stacked one on top of the other (stacking direction in the direction of the axis 19). The laminated cores have grooves or holes into which winding conductors for windings of the electric motor can be laid. The conductors run through the stator in an axial direction and emerge from the stator at the axial ends. The axial ends of the stator 12 are denoted by 12x and 12y. Outside the stator 12, the conductor ends that project out of the stator 12 are connected to free conductor ends of other conductors of the stator and thus form winding heads 12a and 12b, which are situated as regularly arranged cantilevered wire loops at the two ends 12x and 12y of the stator 12.

Said loops may be provided in large numbers in a manner distributed over the circumference of the stator at the two ends 12x, 12y of the stator 12 and may each individually also be of elongate form in a circumferential direction. They may be electrically insulated or uninsulated. The stator 12 commonly bears against, or is rigidly fastened to, the inner wall 13a of a housing 13.

14 denotes the can which is situated in the gap between stator 12 and rotor 11. Generally, said can will completely fill the gap in a circumferential direction, that is to say be of tubular form. In many embodiments, it will also extend all the way through the gap in an axial direction and, at both axial ends (at the left and on the right in FIG. 1), project in each case in an axial direction out of the gap and project beyond the winding heads 12a and 12b.

Here, it is not necessary to assume that a constant cross section is present as viewed over the axial length. The cross section may possibly follow complex shapes of the stator and/or of the rotor. Nevertheless, a common shaping will be one in which at least that part of the can 14 which is situated in the gap is a circular cylindrical tube of constant diameter and, where possible, also of constant wall thickness.

18 denotes the remaining residual gap between stator 12 or can 14 and rotor 11. The thickness is selected in accordance with structural 5 and other requirements. Said thickness extends in the vertical direction of the drawing plane. It may have the order of magnitude of a conventional gap of a machine without a can. In order to enable the winding heads 12a and 12b to be flowed around by cooling fluid, it is necessary for fluid-tight chambers 16a and 16b to be created. Therefore, in addition to the can 14, there are also provided covers 15a, 15b, which extend in a radial direction, and further walls.

In the embodiment of FIG. 1, the covers 15a and 15b run radially outward and lie in a fluid-tight manner against the inner wall 13a of the housing 13. Fluid-tight chambers 16a and 16b are thus formed which are formed in fluid-tight fashion by the can, the respective cover 15 and the respective wall region 13a of the housing. Said chambers are annular chambers which run axially around the inner circumference of the housing 13. In an axial direction, one annular chamber may be formed so as to be fluid-tight in relation to the opposite chamber, though this is not imperative as long as the opposite chamber forms a fluid-tight closure. Where this description refers to a radial extent, this may mean that the extent direction also has a, and preferably a predominant, radial component, or actually runs in a strictly radial direction perpendicular to the axial direction) or relative at 90°±20° or ±5° or ±2° relative thereto. Where an axial extent is referred to, this means that the direction also has an axial component which is preferably greater than the radial component or may actually be purely axial (axially parallel to the axis 19) or at 0°±20° or ±5° or ±2° relative thereto.

The attachment of the cover 15 to the can 14 may be realized in a suitable manner. FIG. 1 shows, on the left, an embodiment in which the cover 15a is integrally molded directly on the can 14 and may then be formed from the same material as the can. The attachment of the cover to the inner wall 13a of the housing 13 may be performed by means of suitable fastening and sealing devices 17.

Here, sealing rings may be provided, or other sealing materials and adhesives or the like. FIG. 1 shows, at the right-hand end of the can 14, a separately formed cover 15b which runs annularly around the inner circumference of the housing 13 and is fastened and sealed off radially at the inside toward the can and radially at the outside toward the inner wall 13b of the housing 13. Suitable fastening and sealing devices 17 are also provided at these locations. It is conceivable for cooling fluid to be supplied and discharged to and from each annular chamber 16a, 16b separately, and for each annular chamber to thus have a dedicated inlet and outlet.

It is however also possible for the annular chambers 16a and 16b to be connected at the two axial ends 12x and 12y of the stator 12 by means of one or more fluid lines which extend in an axial direction.

Here, several possibilities are conceivable, which are illustrated in combination with one another in FIG. 5. FIG. 5 shows the cross section through the stator 12 and adjacent regions in a section direction perpendicular to the axis of rotation, that is to say for example from left to right in FIG. 1. In the stator 12 itself, there may be provided fluid lines 12c, which are formed for example by aligned punched-out portions in the laminations of the laminated core of the stator 12. It is however also conceivable for grooves 30 or milled portions 52 to be provided in the wall 13 of the machine housing, which then each open into the annular chambers. It is likewise possible for grooves 53 to be provided in the radially inner stator surface, which grooves then, together with the can 14, form channels 53.

Also schematically indicated by black dots in FIG. 5 are the electrical lines 51 of the stator winding, which electrical lines project in an axial direction out of the stator at the stator ends and are connected to form the winding heads. By means of one or more of the illustrated grooves or punched-out portions 12c, 52 or 53, axially running connecting lines for the radial annular chambers 16a, 16b can be created.

A cooling structure for the stator as is schematically shown in FIG. 2 can then be realized overall. 16a and 16b symbolize the encircling annular chambers, and 12c symbolizes the axially connecting connecting lines, which may however also be formed by grooves 52, 53. It is then for example possible for one of the annular chambers 16a to have an inlet 16c for cooling fluid and for the other annular chamber 16b to have an outlet 16d.

It is likewise possible (not schematically shown in FIG. 2) for both inlet 16c and outlet 16d to be provided on one of the annular lines 16a or 16b, and for the fluid line between the two to be interrupted, for example by means of suitable guide elements, which may for example be integrally molded on one of the covers 15, such that fluid from the inlet 16 is forced via a first part of the first annular chamber 16a and a part of the axially connecting fluid lines 12c, 52, 53 into the second annular chamber 16b and passes from there via another part of the axial fluid lines 12c, 52, 53 back into the second part of the first annular chamber 16a, and is discharged from there. In general, it may be desirable, in one chamber 16a, 16b, for the cooling fluid to be guided, for example in order to promote mixing or in order to homogenize temperatures. Fluid-guiding elements 30 which are not shown may therefore be provided in the chamber 16a, 16b. Said fluid-guiding elements may project into the fluid flow and divert this or may, as described above, interrupt said fluid flow in a targeted fashion.

Said fluid-guiding elements may be dedicated molded bodies which are placed into and fastened in the chambers. Alternatively, they may be integrally molded on other components, for example on that part of the can 14 which projects beyond the stator and/or on a cover 15 and/or on the housing inner wall 13a, 13b. In general, the illustrated cooling structure with annular chambers and longitudinally connecting fluid lines 12c, 52, 53 form a cooling structure not only for the winding heads 12a, 12b but also for the entire stator 12.

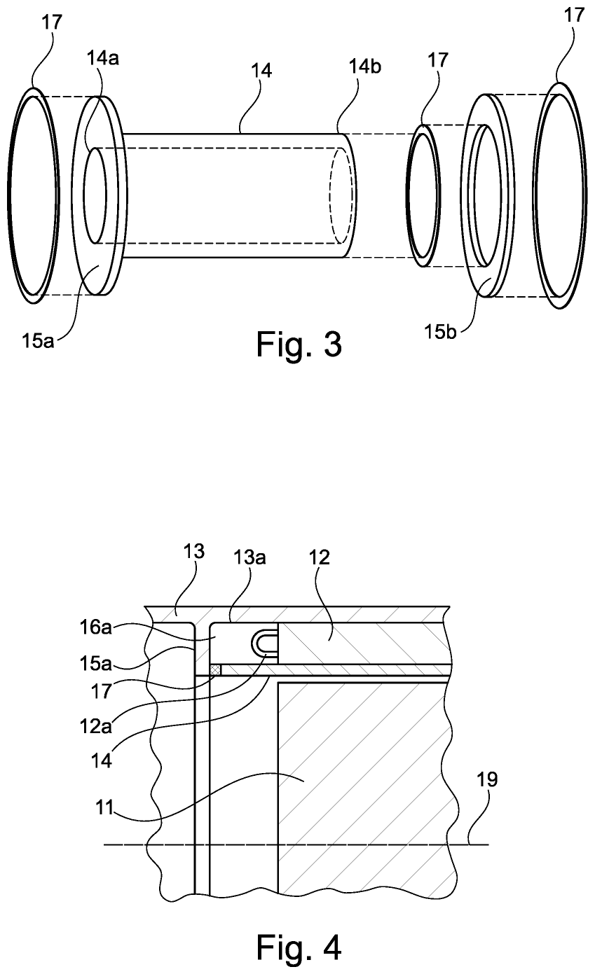

FIG. 3 shows an embodiment of a separately manufactured can 14. It is assumed that a cover 15a extending in a radial direction has already been integrally molded on one end 14a of the can which may thus substantially correspond to the section of FIG. 1. The outer diameter of the tube part 14 corresponds to the inner diameter of the stator 12. The can 14, possibly with integrally molded cover and/or further structural features, for example the abovementioned fluid-guiding elements, is manufactured separately and then, in the embodiment shown, introduced from left to right into the stator.

The second cover 15b may be attached separately to the other end 14b of the can 14. Here, too, suitable sealing devices 17 may be provided both toward the pipe 14 and toward the wall 13 of the machine, which sealing devices also include fastening devices. The fastening may be performed by means of adhesive bonding or the like. The sealing may comprise the use of sealing rings or the like.

A can may however also be merely a circular cylindrical tube. It may have a constant diameter (at the inside and at the outside). The covers may then be attached to both ends as shown schematically on the right in FIG. 3. One possibility for the production of the can is to use ferrite material and in particular ferrite powder with suitable material constants. The ferrite material should have low electrical conductivity, high magnetic permeability and in each case low remanence and coercive field strength.

The ferrite material is preferably isotropic, that is to say has no directional dependency in terms of its magnetic and electrical characteristics. If it is anisotropic, it is preferable for the permeability in a radial direction to be greater than that in an axial direction, and preferably to amount to the maximum and close to the maximum (95% or more of the maximum). This requires a variation of the absolute direction of the directional characteristics of the material in a manner distributed over the circumference. Ferrite material may be prepared as powder and then for example sintered or brought into a stable shape in some other way.

It is also possible for the ferrite material to be mixed with a binding agent and then for the desired molded body to be produced in a suitable manner with the aid of the binding agent. One possibility is to produce a mixture of ferrite material and a carrier material, for example a thermoplastic. For example, the basic materials in powdered or granular form may firstly be coarsely mixed with one another in a cold state and then warmed to above the liquefaction temperature of the thermoplastic, such that the latter becomes more or less liquid. The constituents of ferrite material and thermoplastic material can then be stirred until a homogeneous mixture is present.

The material may then firstly cool again if this is logistically necessary or expedient. The warm mixing may however also be performed directly in or upstream of the further processing machine, that is to say for example by means of a stirring device, which is heated in preferably closed-loop-controlled fashion, at or upstream of the material inlet of injection molding machine or of an extruder. Aside from ferrite material and carrier material, further additives may be provided.

During the actual manufacture of the can, the material may be brought to a temperature at which the mixture is sufficiently processable, that is to say for example viscous/viscid and/or plastically deformable. The processing may comprise molding or extrusion. The molding may comprise injection molding into a suitable cavity. The extrusion may comprise the material being forced out of a suitably shaped annular opening, wherein said material may initially, downstream of the opening, for example also be deformed/widened/narrowed into a flange or cover 15a. In this way, a prefabricated molded part is created, as shown for example in FIG. 3, which may be a separately marketable product. In this respect, a can composed of a material which has ferrite is also a subject of the invention. The material may be a material mixture with ferrite material and plastics material, in particular thermoplastic material.

The can may have further integrally molded structural features, for example an integrally molded cover, a stop or the like. The cover 15 of one of the chambers 16 may be manufactured from a different material than the can 14. Said cover may for example be manufactured from a thermoplastic or from a metallic material or from a thermoset or the like.

FIG. 4 shows an embodiment in which a cover 15a running in a radial directions a structural feature which is integrally molded onto the housing 13 of the machine. Said cover may be a separately integrally molded annular wall which extends radially inward from the housing inner wall 13a and which runs around the circumference of the inner wall 13a of the housing 13. The can 14 may be suitably attached by means of devices 17 in a fixed and fluid-tight manner to the radially inner edge of said cover 15a which is thus integrally molded on the housing inner circumference. By means of the provided material constants of the ferrite material, it is ensured that the disadvantage that arises from the enlargement of the gross gap between stator 12 and rotor 11 is reduced by means of the permeability, which is increased by the ferrite material, of the volume filling in the gap. The fluid inlet for an annular chamber may lie in the region of the housing wall 13 or in the region of the cover or in the region of the can. The same applies to the outlet. Inlet and outlet may have suitable coupling devices in order to be able to attach lines for conducting cooling fluid.

Above, an internally situated rotor has been described as an externally situated so stator. The invention is also applicable to external-rotor motors, that is to say to radially internally situated stators. The can 14 then lies radially at the inside against the static stator and, radially to the outside, has a gap to the rotor which rotates at the outside. The covers 15 extend, beyond the stator ends, radially inward from the can and may extend far as the axis of rotation 19 and thus themselves form a closure at is the one axial end.

Since the stator must be held at the other axial end, it is possible here for the can to transition into a flange-like structure which may also extend radially outward and is fastened in suitably fluid-tight fashion to other structures. It is also conceivable for the winding heads 12a to be cooled in the illustrated manner by means of a chamber or annular chamber 16a only at one axial end (for example 12x). The can may then be dimensioned so as to project beyond the stator only at that axial end and, as shown (for example the left-hand half in FIG. 1), forms the annular chamber 16a. Opposite this, the can 14 may end in the gap 18, following which the rotor or stator may occupy the free volume there.

The ferrite material may have hematite (Fe2O3) and/or magnetite (Fe3O4) in each case individually or as main component or in a suitable mixture ratio. The overall characteristics are, from a magnetic aspect, magnetically soft, as expressed by the above-stated parameters. The machine equipped with the described can may be used as an electric drive of a vehicle. In the case of said machine, the cooling specifically of the winding heads is good even at high load or extremely high peak load, and the efficiency losses of known canned motors are avoided owing to the ferritic can, such that the use of such motors for electrically driven vehicles is possible.

Features in this description are to be regarded as being combinable with one another even if the combination thereof is not expressly described, provided that such a combination is technically possible. Features described in one context, patent claim, one figure or one embodiment are also to be understood as being capable of being taken therefrom and combined with another, even more broadly or more narrowly worded patent claim, figure, context or embodiment, provided that the combination is technically possible.

Explanations of method steps are also to be understood as an explanation of components that implement said method steps, and vice versa.

### LIST OF REFERENCE DESIGNATIONS

10 Electric machine

11 Rotor

12 Stator

12a, 12b Winding heads

12c Fluid guide

12x, 12y Axial ends of the stator

13 Housing

13a, 13b Housing inner wall

14 Can

15a, 15b Cover

16a, 16b Chamber

16c Coolant inlet

16d Coolant outlet

17 Sealant and fastening means

18 Gap

19 Axis of rotation

51 Stator conductor

52 Groove in housing wall

53 Groove in the stator material

What is claimed is:

1. An electric machine having a rotor which is rotatable about an axis, having a stator which is spaced apart from the rotor in a radial direction by a gap and which has one or more stator windings and winding heads at one or both axial stator ends of the stator, having, in the gap, a tube with a fluid-tight wall which extends in an axial direction and in a circumferential direction and which has a wall thickness in a radial direction with respect to the axis of rotation, wherein the tube extends in an axial direction beyond the winding heads of the stator at at least one of the stator ends, having at least one cover which is attached to the at least one axial end of the tube and which extends radially and in a circumferential direction and which covers the winding heads of the at least one axial end of the stator and which serves for forming at least one fluid-tight cooling fluid chamber formed with the tube and the cover, having a cooling fluid inlet and/or a cooling fluid outlet for the at least one cooling fluid chamber, wherein at least regions of the tube (14) are formed with a ferrite material.

2. The machine as claimed in claim 1, in which the tube extends in an axial direction beyond the winding heads of the stator at both stator ends, and wherein the machine has two radially extending covers, which cover the winding heads at both axial ends of the stator, on the two axial ends of the tube such that the at least one cooling fluid chamber includes a pair of cooling fluid chambers each located at one of the axial ends of the stator.

3. The machine as claimed in claim 2, in which, in the stator, there are provided one or more cooling fluid channels which extend in an axial direction and which are fluidically connected to the cooling fluid chambers at the axial ends of the stator, wherein the cooling channels can be formed by punched-out portions in laminated cores of the stator.

4. The machine as claimed in claim 1, having a housing, on the inner wall of which the stator is arranged, wherein a part of the inner wall forms a wall of the at least one cooling fluid chamber and the cover is attached in fluid-tight fashion to the wall part.

5. The machine as claimed in claim 4, in which the housing has, on its inner surface, one or more cooling fluid grooves which extend in an axial direction and which are fluidically connected to the at least one cooling fluid chamber at the axial ends of the stator.

6. The machine as claimed in claim 1, in which the stator is situated radially within the rotor and the cover extends radially inward from the tube.

7. The machine as claimed in claim 1, having one or more cooling fluid guides in the at least one chamber, which cooling fluid guides may be integrally formed on the cover.

8. The machine as claimed in claim 1, in which the cover is formed by a radially extending housing wall or by a surface element which is integrally formed on the housing interior and which extends in a radial direction.

9. (canceled)

10. (canceled)

11. The machine as claimed in claim 1, wherein the wall thickness is between 1 mm and 4 mm.

12. The machine as claimed in claim 1, wherein tube is at least partially formed of a plastoferrite material that is magnetically isotropic or magnetically anisotropic, such that a relative magnetic permeability is greater in the direction of a thickness of the gap than in a direction transversely with respect to the direction of the thickness of the gap.

13. The machine as claimed in claim 1, in which the cover is produced from a non-magnetic material.

14. (canceled)

15. The machine as claimed in claim 1, wherein the tube is a cast part on which the cover may be integrally formed.

16. The machine as claimed in claim 1, wherein the tube is an extruded part.

17. The machine as claimed in claim 1, wherein the machine is an electric motor.

18. (canceled)

19. A can for an electric machine, which can is produced from a material which has ferrite.

20. The can as claimed in claim 19, wherein the can is a molded part sintered from ferrite powder.

21. (canceled)

22. (canceled)

23. The can as claimed in claim 19, having one or more integrally formed structures including a fluid-guiding element.

24. A method for producing a can, having the steps:
providing a granular or powdered ferrite material, and
molding the can in stable form with the ferrite material.

25. The method as claimed in claim 24 wherein molding includes a sintering process.

26. The method as claimed in claim 25, in which the ferrite material is mixed with a carrier material and is molded together with the carrier material, wherein the molding may comprise injection molding or extrusion.

27. (canceled)
